(19) United States
(12) Patent Application Publication
(10) Pub. No.: US 2026/0008129 A1
(43) Pub. Date: Jan. 8, 2026

(54) USE OF LASERS TO SELECTIVELY REMOVE MATERIALS FROM SUBSTRATES

(71) Applicant: University of Virginia Patent Foundation, Charlottesville, VA (US)

(72) Inventors: Mool C. GUPTA, Keswick, VA (US); Mahantesh KHETRI, Charlottesville, VA (US)

(21) Appl. No.: 18/875,233

(22) PCT Filed: Jun. 30, 2023
(86) PCT No.: PCT/US23/69458

§ 371 Date: Dec. 16, 2024

Related U.S. Application Data
(60) Provisional application No. 63/357,066, filed on Jun. 30, 2022.

(51) Int. Cl. B23K 26/361; B23K 26/402; B23K 26/60

(52) U.S. Cl. CPC B23K 26/361; B23K 26/402; B23K 26/60

(57) ABSTRACT

In accordance with the purpose(s) of the present disclosure, as embodied and broadly described herein are methods for selectively removing a material from a surface of a substrate. The method involves applying a laser to the material to remove the material from the substrate. The laser thermally vaporizes the material or de-bonds the material from the substrate to produce particles, and the material particles can be subsequently removed and re-used in subsequent applications. The methods described herein provide an efficient process for removing materials from substrates that would otherwise be discarded.

### CROSS-REFERENCE TO RELATED APPLICATIONS

This application claims the benefit of U.S. Provisional Application No. 63/357,066, filed on Jun. 30, 2022, which is incorporated herein by reference in its entirety.

### BACKGROUND

The life expectancy of solar modules is about twenty-five years. By 2030, solar module waste will reach 8 million tons, and by 2050 it will rise to 78 million tons. Currently, there are two approaches for discarding old or broken photovoltaic (PV) modules; one is to crush the module into powder and separate individual material for resale or use them for landfill. Currently, the PV recycling industry is at the infancy stage as it is not yet economical to recycle old modules to recover the material, and it is hard to compete with the low-cost, environmentally unfriendly landfill approach, which may eventually contaminate underground water with toxic materials. Significant research has been carried out over the last several decades to improve new solar cell efficiency and decrease their manufacturing cost. However, very little research has been done on the recycling of old PV modules.

Currently, recyclable materials are mixed, and it can be difficult to separate high-value components from low value components. Currently, chemical etching in nitric acid is the most common method for the recovery of silver used by the recycling industry. However, use of large amounts of nitric acid can be costly and requires careful handling and disposal of chemicals. Chemical etching further produces silver in a form that must be further processed prior to use.

Despite advances in solar cell fabrication and recycling research, there is still a scarcity of methods useful for recovering silver and other metals found in the solar cell electrical contacts. An ideal method would be mild, using few or no chemicals, and would produce silver in a value added form useful for producing new solar cells as well as in other applications. The method would further be extendable to other substrates in addition to solar panels. These needs and other needs are satisfied by the present disclosure.

### SUMMARY

In accordance with the purpose(s) of the present disclosure, as embodied and broadly described herein are methods for selectively removing a material from a surface of a substrate. The method involves applying a laser to the material to remove the material from the substrate. The laser thermally vaporizes the material or de-bonds the material from the substrate to produce particles, and the material particles can be subsequently removed and re-used in subsequent applications. The methods described herein provide an efficient process for removing materials from substrates that would otherwise be discarded.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described embodiments are usable in all aspects of the disclosure taught herein. Furthermore, the individual features of the dependent claims, as well as all optional and preferred features and modifications of the described embodiments are combinable and interchangeable with one another.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 shows an exemplary set up for applying a laser to selectively remove material from a substrate as described herein.

FIGS. 2A-2E show (A) a typical solar cell image with Ag contact lines and bus bar; (B) and (C) SEM images of silver line on solar cell; (D) EDX elemental mapping for Ag line, and (E) surface profilometry plot for silver line.

FIGS. 3A-3C illustrate the effects of different laser processing parameters for silver line ablation. (A) The laser power is varied from 20% to 80% of 30 W average power while maintaining a fixed laser scanning speed of 500 mm/s and a single pass. (B) The scan speed is varied from 500 mm/s to 2 mm/s while maintaining a fixed power of 40% for a single pass. (C) The number of passes is varied from 1 to 50 passes while maintaining a fixed laser power of 40% and a scan speed of 500 mm/s. Dotted X-Y direction lines indicate the Ag line and the laser scan direction, respectively.

FIG. 4 shows the laser passes using a 355 nm picosecond laser with an average power of 20 W and a repetition rate of 500 kHz.

FIGS. 5A-5C shows (A) scanning electron microscope (SEM) image displaying silver contact line before and after ablation, (B) color of deionized (DI) water (i) before and (ii) after silver ablation, and (C) absorption measurement of colloidal silver nanoparticle solution.

FIGS. 6A-6E show the elemental mapping using energy-dispersive X-ray (EDX) analysis for laser-ablated nanoparticles. (A) Scanning electron microscope (SEM) image, (B) mixed elemental mapping, (C) silver elemental mapping, (D) silicon elemental mapping, and (E) EDX spectrum corresponding to the EDX mapping.

Additional advantages of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### DETAILED DESCRIPTION

Many modifications and other embodiments disclosed herein will come to mind to one skilled in the art to which the disclosed compositions and methods pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. The skilled artisan will recognize many variants and adaptations of the aspects described herein. These variants and adaptations are intended to be included in the teachings of this disclosure and to be encompassed by the claims herein.

Although specific terms are employed herein, they are used in a generic and descriptive sense only and not for purposes of limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided herein can be different from the actual publication dates, which can require independent confirmation.

While aspects of the present disclosure can be described and claimed in a particular statutory class, such as the system statutory class, this is for convenience only and one of skill in the art will understand that each aspect of the present disclosure can be described and claimed in any statutory class.

It is also to be understood that the terminology used herein is for the purpose of describing particular aspects only and is not intended to be limiting. Unless defined otherwise, all technical and scientific terms used herein have the same meaning as commonly understood by one of ordinary skill in the art to which the disclosed compositions and methods belong. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Prior to describing the various aspects of the present disclosure, the following definitions are provided and should be used unless otherwise indicated. Additional terms may be defined elsewhere in the present disclosure.

### Definitions

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by”, “comprising,” “comprises”, “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, the term “consisting essentially of” is intended to include examples encompassed by the term “consisting of.

As used in the specification and the appended claims, the singular forms “a,” “an” and “the” include plural referents unless the context clearly dictates otherwise. Thus, for example, reference to “a metal,” “a substrate,” or “a detergent,” include, but are not limited to, mixtures or combinations of two or more such metals, substrates, or detergents, and the like.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

When a range is expressed, a further aspect includes from the one particular value and/or to the other particular value. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y′, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y′, and ‘greater than z’. In addition, the phrase “about ‘x’ to ‘y’”, where ‘x’ and ‘y’ are numerical values, includes “about ‘x’ to about ‘y’”.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

Disclosed are the components to be used to prepare the compositions of the invention as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds cannot be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions of the invention. Thus, if there are a variety of additional steps that can be performed it is understood that each of these additional steps can be performed with any specific embodiment or combination of embodiments of the methods of the invention.

It is understood that the compositions disclosed herein have certain functions. Disclosed herein are certain structural requirements for performing the disclosed functions, and it is understood that there are a variety of structures that can perform the same function that are related to the disclosed structures, and that these structures will typically achieve the same result.

The term “laser” as used herein is light produced from a laser device.

As used herein, the terms “optional” or “optionally” means that the subsequently described event or circumstance can or cannot occur, and that the description includes instances where said event or circumstance occurs and instances where it does not.

Unless otherwise specified, temperatures referred to herein are based on atmospheric pressure (i.e., one atmosphere).

### Methods for Removing a Material from a Substrate

Described herein are methods for selectively removing a material from a surface of a substrate. The methods involve applying a laser to the material to remove the material from the substrate. The methods described herein provide an efficient process for removing materials from substrates that would otherwise be discarded. From an environmental perspective, the recovery of valuable materials bound to substrates can help to reduce the amount of waste that ends up in landfills.

The methods described utilize lasers in a unique way to thermally vaporize or de-bond materials from substrates that can be subsequently removed and re-used (i.e., recycled) in subsequent applications. Current techniques for removing materials involve harsh chemical procedures such as, for example, chemical etching with concentrated nitric acid. The methods described herein provide a green process that release material particles bound to a substrate. The methods can be used to remove materials such as transition metals (e.g., silver), ceramics, polymers, composites, alloys, or glass bound to a variety of substrates including, but no limited to, metals, ceramics, polymers, composites, alloys, or glass. In one aspect, the bound material and substrate are different substances.

The methods described herein utilize a laser to ablate or detach the material bound to a substrate so that the material is de-bonded from the substrate and can be subsequently removed. As demonstrated in the Examples, the parameters of the laser can be fine-tuned such that only the material is selectively removed from substrate without removing the substrate itself. This results in the removal and isolation of highly pure materials such as valuable metals in an economical and green manner. In one aspect, the material that is selectively removed contains less than 20% by weight substrate, less than 15% by weight substrate, less than 10% by weight substrate, less than 5% by weight substrate, less than 2% by weight substrate, less than 1% by weight substrate, less than 0.5% by weight substrate, or less than 0.1% by weight substrate.

In one aspect, the methods described herein are effective in removing silver bound to a silicon substrate such as, for example, a solar panel or a component of a solar panel. In another aspect, the methods described herein selectively de-bonds one or more silver circuits present in a solar cell or a solar panel. Solar cells (also referred to as photovoltaic cells), are generally composed of a plurality lined silver contacts. The methods described herein are effective in selectively removing (i.e., debonding) the silver from the solar cell.

The life expectancy of solar modules is about twenty-five years. By 2030, the solar module waste will reach 8 million tons, and by 2050 it will rise to 78 million tons. Currently, there are two approaches for discarding old or broken PV modules; one is to crush the module into powder and separate individual material for resale or use them for landfill. Currently, the photovoltaic (PV) recycle industry is at the infancy stage as it is not economical to recycle old modules to recover the material, and it is hard to compete with a low-cost, environmentally unfriendly landfill approach. So, currently, most solar modules are used for landfills. The landfill has environmental issues and could contaminate underground water with toxic materials. Although significant research has been carried out over the last several decades to improve new solar cell efficiency and decrease their manufacturing cost, very little research has been done on the recycling of old PV modules. The recycling industry needs research to help to develop more economical processes that are environmentally friendly for recycling so that higher revenues can be generated. The methods described here address this need.

The selection of the laser can vary depending upon the application as well as the type of material to be moved and the substrate. In one aspect, the selection of the laser wavelength can be sufficient to remove the material from the substrate so that only a minimal amount if any of the substrate is removed.

In one aspect, the laser is an ultraviolet laser. In one aspect, the ultraviolet laser has a wavelength of from about 250 nm to about 450 nm, or about 250 nm, 275 nm, 300 nm, 325 nm, 350 nm, 375 nm, 400 nm, 425 nm, or 450 nm, where any value can be a lower and upper endpoint of a range (e.g., 325 nm to 400 nm). In another aspect, the ultraviolet laser has a wavelength of about 355 nm.

In another aspect, the laser is an infra-red laser. In one aspect, the infra-red laser has a wavelength of from about 900 nm to about 1, 100 nm, or about 900 nm, 925 nm, 950 nm, 975 nm, 1,000 nm, 1,025 nm, 1,050 nm, 1075 nm, or 1,100 nm, where any value can be a lower and upper endpoint of a range (e.g., 1,000 nm to 1,100 nm). In another aspect, the infrared laser has a wavelength of about 1,064 nm.

Depending upon the selection of the laser, the power of the laser can vary. In one aspect, the laser is applied at from about 20% laser power to about 80% laser power, or about 20%, 25%, 30%, 35%, 40%, 45%, 50%, 55%, 60%, 65%, 70%, 75%, or 80%, where any value can be a lower and upper endpoint of a range (e.g., 30% to 50%). In another aspect, the laser is applied at a power of from about 1 W to about 10,000 W, or about 1 W, 10 W, 20 W, 30 W, 40 W, 50 W, 60 W, 70 W, 80 W, 90 W, 100 W, 500 W, 1,000 W, 2,000 W, 3,000 W, 4,000 W, 5,000 W, 6,000 W, 7,000 W, 8,000 W, 9,000 W, or 10,000 W, where any value can be a lower and upper endpoint of a range (e.g., 20 W to 40 W). In another aspect, the laser the laser has a frequency of about 1 Hz to about 100 MHz, or about 1 kHz, 10 kHz, 20 kHz, 30 kHz, 40 kHz, 50 kHz, 60 kHz, 70 KHz, 80 kHz, 90 kHz, 100 kHz, 500 kHz, 1,000 kHz, 2,000 kHz, 3,000 kHz, 4,000 kHz, 5,000 kHz, 6,000 kHz, 7,000 kHz, 8,000 kHz, 9,000 kHz, or 10,000 kHz, where any value can be a lower and upper endpoint of a range (e.g., 1 Hz to 100 MHZ).

In other aspects, the width of the focused laser beam can be modified depending upon the width of the material present on the substrate to be removed. For example, the width of the laser can be approximately the width of the material to be selectively removed to minimize the removal amount of the substrate. In one aspect, the laser has a beam size (i.e., diameter) of from about 1 μm to about 10,000 μm.

The number of times (i.e., passes) the laser is applied to the material can also vary depending upon the amount of material to be removed. In one aspect, the laser is applied to the material from one time to 1,000 times, or 1, 5, 10, 20, 30, 40, 50, 60, 70, 80, 90, 100, 200, 300, 400, 500, 600, 700, 800, 900, or 1,000 times, where any value can be a lower and upper endpoint of a range (e.g., 20 times to 50 times). In another aspect, the laser is applied to the material at a scan speed of from about 1 mm/s to about 10,000 mm/s, or about 100 mm/s, 200 mm/s, 300 mm/s, 400 mm/s, 500 mm/s, 600 mm/s, 700 mm/s, 800 mm/s, 900 mm/s, 1,000 mm/s, 2,000 mm/s, 3,000 mm/s, 4,000 mm/s, 5,000 mm/s, 6,000 mm/s, 7,000 mm/s, 8,000 mm/s, 9,000 mm/s, or 10,000 mm/s, where any value can be a lower and upper endpoint of a range (e.g., 400 mm/s to 600 mm/s).

In one aspect, the laser can be directly applied to the material in dry form. In this aspect, dry material particles are subsequently produced. Here, the laser is not passing through a medium such as a liquid or a solid. The material particles that are produced can subsequently be removed by techniques know in the art such as, for example, by a vacuum under an atmosphere of air or an inert atmosphere of nitrogen and/or argon.

In another aspect, the laser can first pass through the substrate and then contact the material bound to the surface of the substrate to remove the material. For example, when the substrate is a silicone substrate such as those used solar panels, the methods described herein are effective in removing the material such as silver by this approach. In this aspect, the laser is applied to the side of the silicone substrate opposite to the side where the material is bound.

In another aspect, prior to applying the laser to the substrate with the bound material, the substrate is immersed in a liquid. Depending upon the substrate, the substrate can be partially or completely immersed in the liquid. In one aspect, the liquid comprises water, a polar organic solvent, or a combination thereof. In one aspect, the liquid comprises water, an alcohol, or a combination thereof. Examples of alcohols include, but are not limited to, methanol or ethanol. In another aspect, the alcohol can be a polyol such as a glycol.

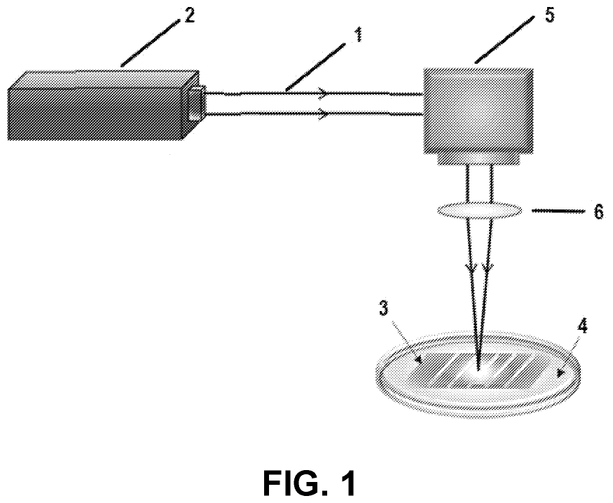

An exemplary schematic of this aspect is provided in FIG. 1. Referring to FIG. 1, a laser beam 1 produced from laser 2 is directed onto substrate 3, which is immersed in liquid 4. The laser beam 1 is applied to the substrate with bound material using a galvanometer 5 and F-theta lens 6 arrangement to specifically target or direct the laser to a specific cite on the substrate where the material is located. The laser beam is applied to the bound material to remove as much material as possible by varying the laser parameters as discussed above. In one aspect, the laser is mounted on translation stage. Here, the laser can be moved in any direction (i.e., x- or y-axis) relative to the substrate to selectively remove the material from the substrate.

After the laser has been applied, the material particles present in the liquid medium can be removed using techniques known in the art. For example, the liquid medium containing the material particles can be ultrasonicated, centrifuged, and/or filtered to remove the material particles from the liquid medium.

In one aspect, a surfactant can be used to reduce or prevent agglomeration of the material particles present in the liquid medium. In one aspect, the surfactant is added to the liquid medium after the material bound to the substrate has been exposed to the laser. In another aspect, the surfactant is added to the liquid medium before the material bound to the substrate has been exposed to the laser.

In one aspect, the surfactant is a nonionic surfactant. Examples of nonionic surfactants include the condensation products of a higher aliphatic alcohol, such as a fatty alcohol, containing about 8 to about 20 carbon atoms, in a straight or branched chain configuration, condensed with ethylene oxide. Examples of such nonionic ethoxylated fatty alcohol surfactants are the Tergitol™ 15-S series from Union Carbide and Brij™ surfactants from ICI. Tergitol™ 15-S Surfactants include C₁₁-C₁₅ secondary alcohol polyethyleneglycol ethers. Brij™97 surfactant is polyoxyethylene(10) oleyl ether; Brij™58 surfactant is polyoxyethylene(20) cetyl ether; and Brij™ 76 surfactant is polyoxyethylene(10) stearyl ether.

Another useful class of nonionic surfactants include the polyethylene oxide condensates of one mole of alkyl phenol containing from about 6 to 12 carbon atoms in a straight or branched chain configuration, with ethylene oxide. Examples of nonreactive nonionic surfactants are the Igepal™ CO and CA series from Rhone-Poulenc. Igepal™ CO surfactants include nonylphenoxy poly(ethyleneoxy)ethanols. Igepal™ CA surfactants include octylphenoxy poly(ethyleneoxy)ethanols.

Another useful class of hydrocarbon nonionic surfactants include block copolymers of ethylene oxide and propylene oxide or butylene oxide. Examples of such nonionic block copolymer surfactants are the Pluronic™ and Tetronic™ series of surfactants from BASF. Pluronic™ surfactants include ethylene oxide-propylene oxide block copolymers. Tetronic™ surfactants include ethylene oxide-propylene oxide block copolymers.

In other aspects, the nonionic surfactants include sorbitan fatty acid esters, polyoxyethylene sorbitan fatty acid esters and polyoxyethylene stearates. Examples of such fatty acid ester nonionic surfactants are the Span™, Tween™, and Myj™ surfactants from ICI. Span™ surfactants include C₁₂-C₁₈ sorbitan monoesters. Tween™ surfactants include poly(ethylene oxide) C₁₂-C₁₈ sorbitan monoesters. Myj™ surfactants include poly(ethylene oxide) stearates.

In one aspect, the nonionic surfactant can include polyoxyethylene alkyl ethers, polyoxyethylene alkyl-phenyl ethers, polyoxyethylene acyl esters, sorbitan fatty acid esters, polyoxyethylene alkylamines, polyoxyethylene alkylamides, polyoxyethylene lauryl ether, polyoxyethylene cetyl ether, polyoxyethylene stearyl ether, polyoxyethylene oleyl ether, polyoxyethylene octylphenyl ether, polyoxyethylene nonylphenyl ether, polyethylene glycol laurate, polyethylene glycol stearate, polyethylene glycol distearate, polyethylene glycol oleate, oxyethylene-oxypropylene block copolymer, sorbitan laurate, sorbitan stearate, sorbitan distearate, sorbitan oleate, sorbitan sesquioleate, sorbitan trioleate, polyoxyethylene sorbitan laurate, polyoxyethylene sorbitan stearate, polyoxyethylene sorbitan oleate, polyoxyethylene laurylamine, polyoxyethylene laurylamide, laurylamine acetate, hard beef tallow propylenediamine dioleate, ethoxylated tetramethyldecynediol, fluoroaliphatic polymeric ester, polyether-polysiloxane copolymer, and the like. In another aspect, the surfactant is Triton X-100, which is t-octylphenoxypolyethoxyethanol, polyethylene glycol tert-octylphenyl ether.

After the laser has been applied, the material particles present in the liquid medium with surfactant can be removed using techniques known in the art. For example, the liquid medium containing the material particles can be ultrasonicated, centrifuged, and/or filtered to remove the material particles from the liquid medium.

The methods described herein permit the removal of materials bound to substrates in high yields without the use of harsh chemicals. For example, the methods described herein can remove materials and produce material particles having a purity of greater than 90%, greater than 95%, greater than 99%, or greater than 99.5%. In certain aspects, it is desirable to isolate the material particles as nanoparticles. For example, silver nanoparticles are considerably more valuable than larger silver particles. Silver nanoparticles occupy a large market space and are used in numerous applications such as cosmetics, water treatment, textiles, imaging, bio-sensing, and pharmaceuticals. Thus, in certain aspects, the methods described herein provide an efficient method for producing material nanoparticles from spent or expired devices that can be recycled into other useful products. In one aspect, the material nanoparticles having an average diameter of from about 1 nm to about 50,000 nm, or about 50 nm to about 500 nm, or about 100 nm to about 300 nm.

### Aspects

Aspect 1. A method for removing a material from a surface of a substrate, the method comprising applying a laser to the material to remove the material from the substrate.

Aspect 2. The method of Aspect 1, prior to applying a laser to the material, immersing the substrate in a liquid.

Aspect 3. The method of Aspect 1 or 2, wherein the substrate comprises a metal, ceramics, polymer, composites, alloy, or glass.

Aspect 4. The method of Aspect 1 or 2, wherein the substrate comprises a silicon substrate.

Aspect 5. The method of Aspect 4, wherein the silicon substrate comprises a solar panel or a component of a solar panel.

Aspect 6. The method of any one of Aspects 1-5, wherein the material comprises a transition metal.

Aspect 7. The method of any one of Aspects 1-5, wherein the material comprises silver.

Aspect 8. The method of any one of Aspects 1-5, wherein the material comprises a ceramic, polymer, composite, alloy, or glass.

Aspect 9. The method of any one of Aspects 1-8, wherein the method selectively de-bonds one or more silver lines present in a solar cell or a solar panel.

Aspect 10. The method of any one of Aspects 2-9, wherein the liquid comprises water, an alcohol, or a combination thereof.

Aspect 11. The method of any one of Aspects 2-9, wherein the liquid comprises water, methanol, ethanol, or any combination thereof.

Aspect 12. The method of any one of Aspects 1-11, wherein the laser is applied to the material at a scan speed of from about 100 mm/s to about 1000 mm/s.

Aspect 13. The method of any one of Aspects 1-12, wherein the laser is applied at from about 20% laser power to about 80% laser power.

Aspect 14. The method of any one of Aspects 1-13, wherein the laser has an average energy of from about 1 W to about 100 W.

Aspect 15. The method of any one of Aspects 1-14, wherein the laser is applied to the material from one time to 1,000 times.

Aspect 16. The method of any one of Aspects 1-15, wherein the laser has a beam size of from about 20 μm to about 100 μm.

Aspect 17. The method of any one of Aspects 1-16, wherein the laser has a frequency of about 1 kHz to about 100 KHz.

Aspect 18. The method of any one of Aspects 1-17, wherein the laser is an ultraviolet laser.

Aspect 19. The method of any one of Aspects 1-17, wherein the laser is an infra-red laser.

Aspect 20. The method of any one of Aspects 1-19, wherein the laser is applied to the m material using a galvanometer.

Aspect 21. The method of any one of Aspects 1-20, wherein the laser is mounted on translation stage.

Aspect 22. The method of any one of Aspects 2-21, where the material is removed from the liquid after step (b).

Aspect 23. The method of any one of Aspects 1-22, wherein after the laser is applied to the material, free material particles are produced that are subsequently removed by a vacuum.

Aspect 24. The method of any one of Aspects 1-22, wherein the material removed from the substrate comprises a mixture of nanoparticles and microparticles.

Aspect 25. The method of any one of Aspects 1-22, wherein the material removed from the substrate comprises nanoparticles having an average diameter of from about 1 nm to about 5,000 nm.

Aspect 26. The method of any one of Aspects 1-25, wherein the material has a purity of greater than 80% once removed from the substrate.

Now having described the aspects of the present disclosure, in general, the following Examples describe some additional aspects of the present disclosure. While aspects of the present disclosure are described in connection with the following examples and the corresponding text and figures, there is no intent to limit aspects of the present disclosure to this description. On the contrary, the intent is to cover all alternatives, modifications, and equivalents included within the spirit and scope of the present disclosure.

### Examples

The following examples are put forth so as to provide those of ordinary skill in the art with a complete disclosure and description of how the compounds, compositions, articles, devices and/or methods claimed herein are made and evaluated, and are intended to be purely exemplary of the disclosure and are not intended to limit the scope of what the inventors regard as their disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

### Experimental Setup

The setup shown in FIG. 1 was used in the experiments herein. The pulsed laser beam is directed onto the Ag contact line of the solar cell sample, which was submerged in deionized (DI) water, and the beam was scanned along the silver lines using a galvanometer and F-theta lens arrangement. Prior to the scan, visible reference laser light and cameras were employed to ensure the accurate alignment of the laser beam spot movement on the silver line.

### Surface Morphology Studies

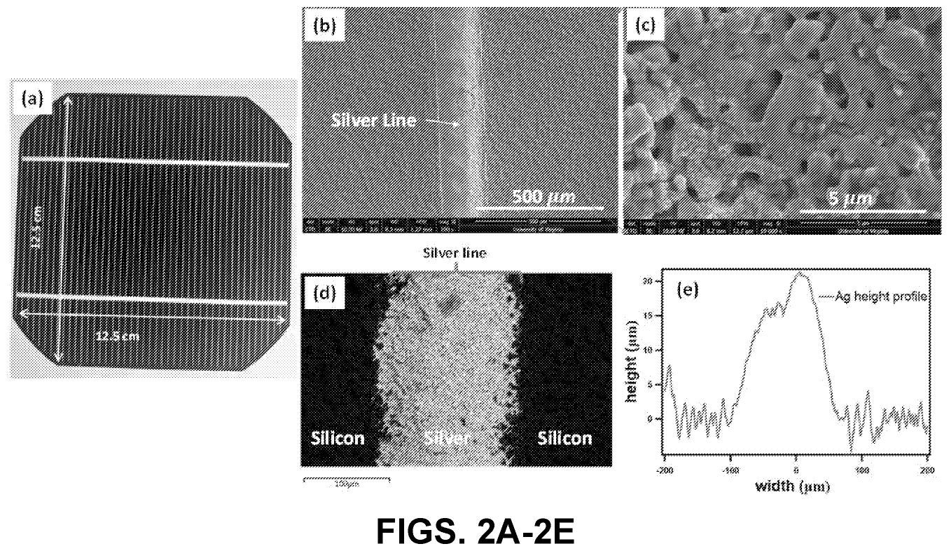

Structural and optical investigations of the bare silver contact line on the solar cell were conducted. The solar cell has Ag contact lines and a bus bar across its surface area, as shown in FIG. 2A. Scanning electron microscopy images in FIGS. 2B and 2C reveal the granular morphology of the silver contact material. Energy dispersive x-ray analysis (EDX) mapping in FIG. 2D shows the distribution of silver across the contact line. To confirm the height and width of the silver contact line, profilometry investigations were performed and it was found that it has a height of approximately 20 micrometers and a width of approximately 170 microns and is not perfectly flat.

### Laser Parameters

### Nanosecond IR Laser Parameters (λ=1064 nm):

The laser had an average power of approximately 30 W and a pulsed width of approximately 10 nanoseconds, with a repetition rate of 30 kHz. Different laser powers, laser scan speeds, and the number of passes were investigated.

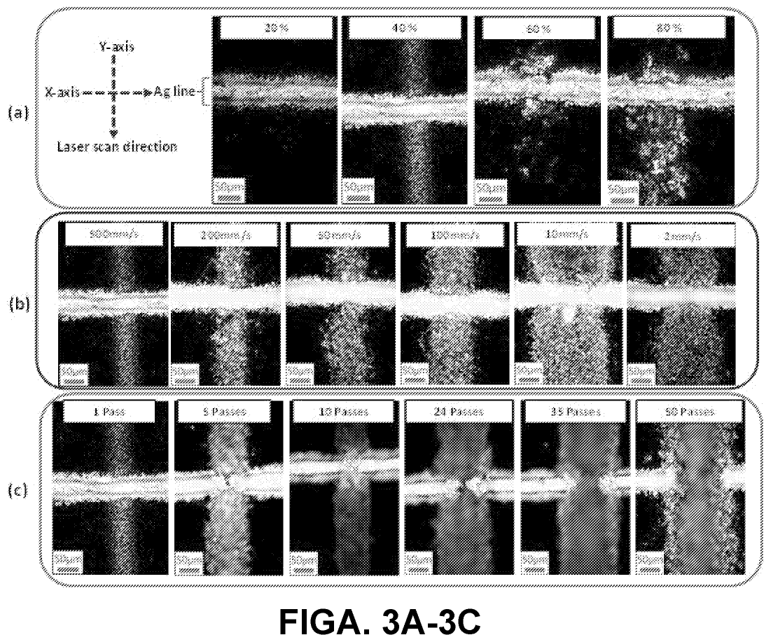

To ensure silver ablation with minimal silicon ablation, the following parameters were investigated:
the laser power from 20% to 80% was varied while keeping the laser scan speed fixed at 500 mm/s and performing a single pass shown in FIG. 3A;
the laser scan speed was varied from 500 mm/s to 2 mm/s while keeping the laser power fixed at 40% for a single pass shown in FIG. 3B; and
the number of passes from 1 to 50 was varied while keeping the laser power fixed at 40% and the scan speed fixed at 500 mm/s shown in FIG. 3C.

The results showed that a laser power of 40%, a scan speed of 500 mm/s, and approximately 35 passes were sufficient to ablate silver with minimal silicon ablation.

### Picosecond UV Laser Parameters (λ=355 nm)

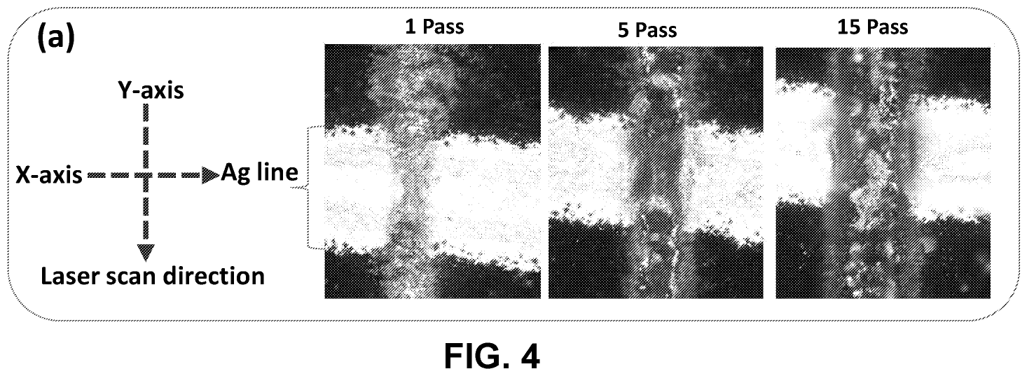

A 355 nm picosecond laser, which had an average power of 20 W and a repetition rate of 500 kHz, was investigated. FIG. 4 displays experimental outcomes for various laser passes at 20 W laser power and a 500 mm/s scanning rate. The results indicate that the picosecond laser can ablate silver material with approximately 8-10 passes.

### Silver Nanoparticles Fabrication and Characterization

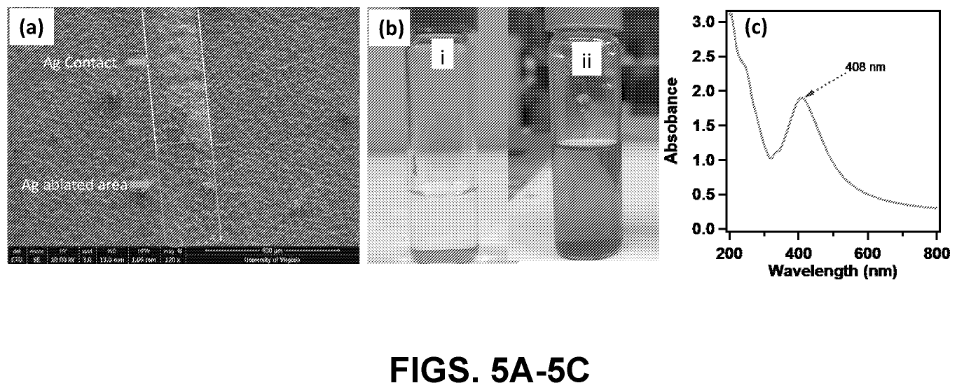

A picosecond laser was used to successfully ablate a silver contact line, as shown in FIG. 5A. The SEM image depicts the Ag contact line marked by a white dotted line, and the red highlighted box shows the ablation area.

The ablation was performed in DI water, and FIG. 5B (i) displays the color of normal DI color, while FIG. 5B (ii) shows the presence of Ag nanoparticles in water as a yellow color. The presence of silver ablation in DI water was confirmed using optical absorption measurement, which revealed an absorption peak at 408 nm corresponding to the silver nanoparticle absorption.

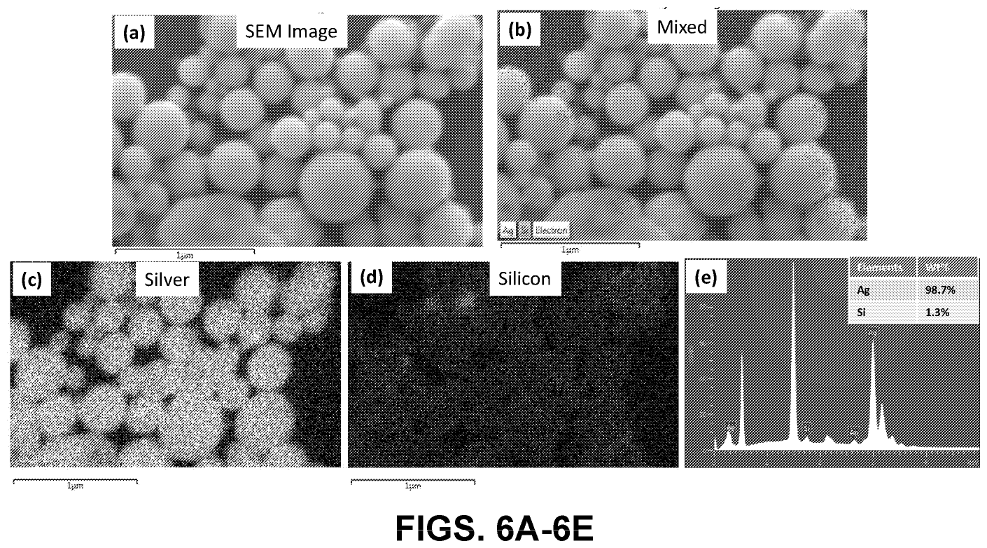

The silver nanoparticles colloidal solution was centrifuged and drop casted onto a sapphire substrate for SEM and EDS analysis. FIG. 6 depicts the SEM image of the fabricated silver nanoparticles, which were spherical and ranged in size from 50 nm to 500 nm, with an average size of 230 nm. EDX elemental mapping was conducted to investigate any impurities in the nanoparticles. FIG. 6B is the mixed overlapped image of silver mapping (shown in FIG. 6C) and silicon mapping (shown in FIG. 6D), indicating that most of the particles are silver nanoparticles with a small amount of silicon nanoparticles. The EDX spectrum in FIG. 6E shows that the weight percent of silver is ˜98.7%, and silicon is ˜1.3%.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

1. A method for removing a material from a surface of a substrate, the method comprising applying a laser to the material to remove the material from the substrate.

2. The method of claim 1, prior to applying a laser to the material, immersing the substrate in a liquid.

3. The method of claim 1, wherein the substrate comprises a metal, ceramics, polymer, composites, alloy, or glass.

4. The method of claim 1, wherein the substrate comprises a silicon substrate.

5. The method of claim 4, wherein the silicon substrate comprises a solar panel or a component of a solar panel.

6. (canceled)

7. The method of claim 1, wherein the material comprises silver.

8. The method of claim 1, wherein the material comprises a transition metal, a ceramic, polymer, composite, alloy, or glass.

9. The method of claim 1, wherein the method selectively de-bonds one or more silver lines present in a solar cell or a solar panel.

10. The method of claim 2, wherein the liquid comprises water, an alcohol, or a combination thereof.

11. The method of claim 2, wherein the liquid comprises water, methanol, ethanol, or any combination thereof.

12. The method of claim 1, wherein the laser is applied to the material at a scan speed of from about 100 mm/s to about 1000 mm/s.

13. The method of claim 1, wherein
the laser is applied at from about 20% laser power to about 80% laser power, or
the laser has an average energy of from about 1 W to about 100 W, or
the laser is applied to the material from one time to 1,000 times, or
the laser has a beam size of from about 20 μm to about 100 μm, or
the laser has a frequency of about 1 kHz to about 100 KHz.

14-17. (canceled)

18. The method of claim 1, wherein the laser is an ultraviolet laser or an infra-red laser.

19. (canceled)

20. The method of claim 1, wherein the laser is applied to the material using a galvanometer.

21. The method of claim 1, wherein the laser is mounted on translation stage.

22. The method of claim 2, where the material is removed from the liquid after step (b).

23. The method of claim 1, wherein after the laser is applied to the material, free material particles are produced that are subsequently removed by a vacuum.

24. The method of claim 1, wherein the material removed from the substrate comprises a mixture of nanoparticles and microparticles.

25. The method of claim 1, wherein the material removed from the substrate comprises nanoparticles having an average diameter of from about 1 nm to about 5,000 nm.

26. The method of claim 1, wherein the material has a purity of greater than 80% once removed from the substrate.
